(19) United States
(12) Patent Application Publication
(10) Pub. No.: US 2025/0303675 A1
(43) Pub. Date: Oct. 2, 2025

(54) Repositionable Laminated Film Assembly with Enhanced Adhesion for Glass Surfaces

(71) Applicant: Jay Allan Winick

(72) Inventor: Jay Allan Winick

(21) Appl. No.: 18/616,380

(22) Filed: Mar. 26, 2024

(51) Int. Cl. B32B 17/10

(52) U.S. Cl. CPC B32B 17/10458; B32B 17/10018; B32B 17/1033; B32B 17/10449; B32B 17/10688; B32B 2307/42; B32B 2307/748

(57) ABSTRACT

The invention discloses a laminated film assembly for application to glass surfaces, comprising a cellulose triacetate (CTA) layer designed to polarize light, a physical adhesion layer, and an intermediate layer containing an adhesive. The physical adhesion layer, devoid of chemical adhesives, utilizes mechanical adhesion and intermolecular forces to secure the assembly to the glass. This layer ensures ease of application and removal, addressing the limitations of traditional adhesive methods. The intermediate layer serves to bond the CTA layer to the physical adhesion layer, ensuring the structural integrity and functionality of the laminated film. This invention provides a novel approach to applying polarizing films to glass surfaces, offering significant improvements in installation efficiency, reusability, and versatility of use, particularly suitable for enhancing privacy and security on large video displays.

### FIELD OF INVENTION

The present invention relates generally to the field of window film technology, specifically to a laminated film assembly designed for application on glass surfaces. It relates to improvements in adhesive layers for secure, repositionable attachment of polarizing films to glass, enhancing privacy and display security without the use of chemical adhesives.

### BACKGROUND

The use of cellulose triacetate (CTA) film in the realm of window film technology marks a pivotal step forward in the pursuit of enhancing privacy and security measures on large video displays. This material, which stands out for its unique property of polarizing light, has become a cornerstone in applications requiring the obscuration of display contents. Despite its widespread adoption and inherent advantages, the application process of CTA film onto glass surfaces has been fraught with challenges, primarily due to the limitations of existing adhesive methods and the physical properties of the film itself.

Historically, the application of window films has relied on a wet installation method. This method involves the use of a slip solution to prevent premature adhesion of the film to the glass, allowing for adjustments and positioning before final adherence. While effective for films utilizing traditional acrylic-based adhesives, this approach introduces significant complications when applied to CTA films. CTA's propensity to absorb moisture complicates the installation process, leading to potential issues such as film curling away from the glass surface. This phenomenon not only complicates the installation process but also necessitates continuous attention and adjustment by the installer to ensure proper adherence, thereby increasing both the time and labor involved in the application.

The challenges are further compounded by the characteristics of acrylic adhesives traditionally used in the window film industry. While these adhesives have been the standard for securing films to glass, their chemical nature means that once the film is in place, repositioning or removing the film without leaving residue becomes nearly impossible. This limitation not only restricts the flexibility of use but also impacts the practicality of CTA films for applications where temporary or adjustable installation is desirable. Moreover, the interaction between the acrylic adhesive and the CTA film in the presence of the slip solution can exacerbate the moisture absorption issue, leading to a decrease in the quality of the installation and an increase in the potential for errors during the application process.

Recognizing these limitations, the industry has been in search of innovative solutions that can address the drawbacks associated with the traditional wet application method and the use of acrylic-based adhesives. The goal has been to find a method that not only simplifies the installation process but also enhances the durability and flexibility of CTA films. Such a solution would need to accommodate the unique properties of CTA, allowing for moisture resistance, easy repositioning, and removal without compromising the integrity of the film or the surface to which it is applied.

A solution is needed that can bypass the challenges of moisture absorption, curling, and adhesive residue would not only streamline the installation process but also expand the range of potential applications for CTA films. By addressing the core issues of installation complexity, labor intensity, and film reusability, such advancements promise to elevate the utility and versatility of CTA films, making them more accessible and effective for a broader spectrum of privacy and security applications.

It is within this context that the present invention is provided.

### SUMMARY

The present invention provides a laminated film assembly designed for application on glass surfaces, primarily to offer a method of securing a cellulose triacetate (CTA) layer to glass. The assembly comprises a CTA layer for polarizing light, a physical adhesion layer for attaching the assembly to the glass surface through mechanical adhesion and intermolecular forces, and an intermediate layer that bonds the CTA layer to the physical adhesion layer using an adhesive. This structure facilitates the secure attachment of the film to glass surfaces without the need for chemical adhesives, thereby allowing for easy application and removal.

In some embodiments, the physical adhesion layer includes materials such as Polyethylene Terephthalate (PET), silicone, Polyvinyl Chloride (PVC), and Thermoplastic Polyurethane (TPU). These materials are selected for their ability to adhere effectively to glass through physical means, offering an alternative to traditional chemical adhesives and providing flexibility in the choice of materials based on specific application needs.

In further embodiments, the intermediate layer comprises adhesives like two-part epoxy and polyurethane glue. These adhesives are chosen for their strong bonding capabilities, ensuring that the CTA layer remains securely attached to the physical adhesion layer, thus maintaining the integrity and functionality of the laminated film assembly.

In some embodiments, a surface modification is applied to the physical adhesion layer to enhance its mechanical adhesion and intermolecular forces. The inclusion of texturing increases the surface area available for adhesion, improving the bond strength between the film assembly and the glass surface.

In other embodiments, the physical adhesion layer is optimized in thickness to balance flexibility and rigidity. This balance ensures that the film can be easily applied to and removed from the glass surface while maintaining its structural integrity during use.

In some embodiments, the CTA layer undergoes a treatment process to enhance its light-polarizing efficiency. This treatment improves the film's ability to obscure the contents of a display, providing enhanced privacy and security.

In further embodiments, the physical adhesion layer is designed to be repositionable. This feature allows the film to be detached and reattached to the glass surface multiple times without losing adhesion quality or leaving residue, offering greater versatility in use.

In some embodiments, the physical adhesion layer incorporates micro-suction structures. These structures facilitate the creation of a vacuum seal, enhancing the adhesion to the glass surface through mechanical means rather than chemical adhesion

In other embodiments, the assembly is configured to allow for the transmission of touchscreen signals. This configuration enables the film to be used on touchscreen displays without interfering with the display's interactive capabilities.

In some embodiments, the laminated film assembly includes an ultraviolet (UV) protection layer. This layer is either integrated into the CTA layer or disposed on the opposite side, providing UV filtering properties when applied to the glass surface, thereby offering additional functionality beyond privacy and display security.

### BRIEF DESCRIPTION OF THE DRAWINGS

Various embodiments of the invention are disclosed in the following detailed description and accompanying drawings.

FIG. 1 illustrates an example cross-sectional view of the laminated film assembly adhered to a glass surface, showing the layering from the glass surface to the CTA layer.

FIG. 2 illustrates an example perspective view of an LED screen of a TV with the laminated film assembly applied over a portion of it, showing the light filtering effect achieved by the orientation of the CTA layer.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### Detailed Description and Preferred Embodiment

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” indicate an acceptable degree of error or variation in measurements, usually within 20%, preferably within 10%, and more preferably within 5% of a given value or range. Numerical values provided in this description are approximate unless stated otherwise.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The term “cellulose triacetate (CTA) layer,” as used herein, refers to a film layer capable of polarizing light. This layer is not limited to cellulose triacetate but may include any suitable material with light-polarizing properties. Examples of such materials include, but are not limited to, other cellulose derivatives and polymers known to those skilled in the art to exhibit similar functionality.

The “physical adhesion layer” described in the claims denotes a layer designed to secure the laminated film assembly to a glass surface without relying on chemical adhesives. This layer employs mechanical adhesion and intermolecular forces for attachment. Suitable materials for the physical adhesion layer may include, without limitation, Polyethylene Terephthalate (PET) which is the preferred embodiment, silicone, Polyvinyl Chloride (PVC), and Thermoplastic Polyurethane (TPU). These materials are chosen for their ability to adhere to glass through non-chemical means.

Furthermore, the “intermediate layer” incorporates an adhesive that bonds the CTA layer to the physical adhesion layer. The scope of suitable adhesives includes, but is not limited to, two-part epoxy and polyurethane glue. These adhesives are selected for their strong bonding capabilities and flexibility.

### DESCRIPTION OF DRAWINGS

The present invention relates to a laminated film assembly specifically designed for application to glass surfaces, with a focus on the method and materials used to secure a cellulose triacetate (CTA) film to such surfaces. The assembly incorporates a physical adhesion layer, distinct from traditional adhesive methods, to attach the CTA film. This layer utilizes Polyethylene Terephthalate (PET) to achieve attachment through mechanical adhesion and intermolecular forces, rather than through chemical bonding. This approach marks a departure from conventional techniques that rely on chemical adhesives to form permanent bonds.

Mechanical adhesion in this context is facilitated by direct physical contact and the application of pressure. This process enables the PET layer to conform closely to the microscopic features of the glass surface, thereby increasing the contact area and enhancing the strength of the adhesion. The adhesion mechanism is supported by intermolecular forces, including Van der Waals forces-comprising London dispersion forces, dipole-dipole interactions, and hydrogen bonding. Despite the relatively modest strength of these forces individually, their collective effect across the interface between the PET and glass surfaces significantly contributes to the stability of the attachment.

For the purposes of this invention, the PET layer is better described as a non-chemical adhesive layer or a physical adhesion layer. This terminology more accurately reflects the nature of the adhesion process, which does not rely on chemical reactions to achieve bonding. The characteristics of this physical adhesion method-ease of application, the potential for repositioning, and clean removal without residue-represent improvements over the limitations associated with the use of acrylic-based and other chemical adhesives.

The invention also contemplates the use of materials beyond PET that exhibit similar properties conducive to physical adhesion. Such materials, including silicone, specific variants of PVC (Polyvinyl Chloride), and TPU (Thermoplastic Polyurethane), share the capacity for mechanical adhesion and engagement through intermolecular forces. The choice among these materials for the physical adhesion layer would be guided by considerations of transparency, flexibility, durability, and compatibility with the CTA layer.

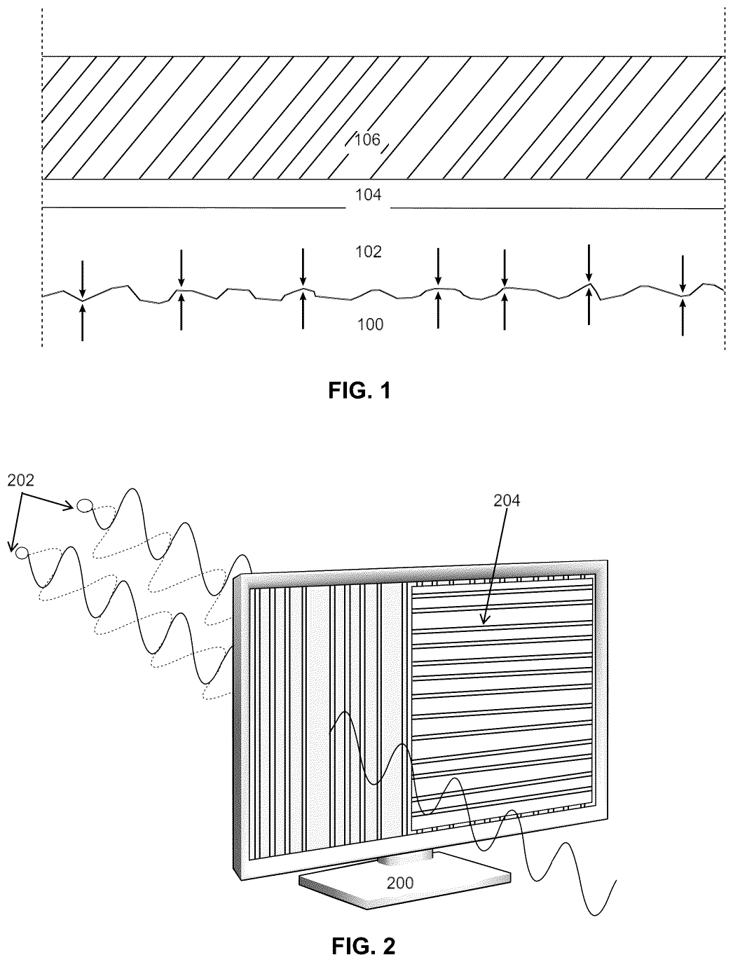

FIG. 1 provides a cross-sectional depiction of the laminated film assembly adhered to a glass surface. At the base of this assembly is the glass surface 100, representing the substrate to which the film is applied. Directly above the glass surface 100 is the physical adhesion layer 102, which is in direct contact with the glass. This layer is critical for securing the entire assembly to the glass without the use of chemical adhesives, relying instead on mechanical adhesion and intermolecular forces (indicated by arrows) to maintain attachment. The physical adhesion layer 102 is designed to conform to the microscopic contours of the glass surface 100 (which are drawn larger than the reality for illustrative purposes), enhancing the contact area and thereby the strength of the bond formed through intermolecular forces, including Van der Waals forces.

Positioned above the physical adhesion layer 102 is the intermediate layer 104, which serves a pivotal role in bonding the uppermost CTA layer 106, which has the polarizing properties discussed already, to the underlying physical adhesion layer 102. The intermediate layer 104 contains an adhesive that is compatible with both the CTA layer 106 and the physical adhesion layer 102, ensuring a secure and durable bond. This adhesive is selected for its ability to form strong bonds while maintaining the flexibility and integrity of the laminated film assembly.

The topmost layer in the assembly is the CTA layer 106, specifically designed to polarize light passing through it. This layer's placement above the intermediate layer 104 allows it to effectively obscure the contents of the display from view, serving the primary purpose of the laminated film assembly. The CTA layer 106, being the final component of the assembly, interacts with light before any other component, ensuring that the polarization effect is unimpeded by the underlying layers.

FIG. 2 illustrates a perspective view of an LED screen of a television 200 with a section of the laminated film assembly, as described in the present invention, applied over a portion of it. The LED screen 200 is depicted filtering out all oscillations of a light source 202, visible behind the screen, except for those that are vertical. The key component of the laminated film assembly in this configuration is the cellulose triacetate (CTA) layer 204, which is strategically oriented perpendicular to the vertical oscillations. This orientation allows the CTA layer 204 to filter out the remaining light oscillations that pass through the LED screen 200, resulting in a distinct black rectangle 206 where the assembly has been placed over the screen.

The LED screen 200 serves as the backdrop for demonstrating the effectiveness of the laminated film assembly in controlling light transmission. The light source 202, positioned behind the LED screen 200, emits light that includes oscillations in multiple directions. The LED screen's inherent properties allow it to filter out all but vertical oscillations of the light, showcasing the screen's ability to selectively polarize light.

The application of the CTA layer 204 of the laminated film assembly over a portion of the LED screen 200 further demonstrates the polarizing effect of the CTA layer. By aligning the CTA layer 204 so that its polarizing axis is perpendicular to the vertical oscillations allowed by the LED screen 200, the assembly effectively eliminates the transmission of the remaining light oscillations. This interaction results in the visualization of the black rectangle 206, providing a clear, visual representation of the polarizing capability of the CTA layer 204 in conjunction with the LED screen's filtering properties.

A user will be able to peel off a corner of the laminated film assembly from the television screen without leaving any residue. This ease of removal is attributed to the physical adhesion layer within the assembly, which secures the film to the screen through mechanical adhesion and intermolecular forces, rather than chemical bonding, allowing for clean and residue-free detachment.

After detaching the film, the individual may proceed to reapply the same laminated film assembly to a different area of the television screen as many times as they like. This action illustrates the assembly's capability for multiple reattachments while still maintaining a strong adhesion each time. The ability to detach and reattach the film assembly without compromising its adhesive quality or leaving residues on the screen surface highlights the assembly's practicality and adaptability for various uses, including but not limited to, temporary adjustments for privacy or to obscure screen contents as needed.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the laminated film assembly of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A laminated film assembly for application to a glass surface, comprising:
a cellulose triacetate (CTA) layer configured to polarize light passing through the glass surface when the laminated film assembly is applied thereto;
a physical adhesion layer disposed on a side of the CTA layer, the physical adhesion layer, wherein the physical adhesion layer is configured to adhere to the glass surface through mechanical adhesion and intermolecular forces without the use of chemical adhesives; and
an intermediate layer disposed between the CTA layer and the physical adhesion layer, wherein the intermediate layer comprises an adhesive, the intermediate layer being configured to bond the CTA layer to the physical adhesion layer.

2. The laminated film assembly of claim 1, wherein the physical adhesion layer comprises a material selected from the group consisting of Polyethylene Terephthalate (PET), silicone, Polyvinyl Chloride (PVC), and Thermoplastic Polyurethane (TPU).

3. The laminated film assembly of claim 1, wherein the intermediate layer comprises an adhesive selected from the group consisting of two-part epoxy and polyurethane glue.

4. The laminated film assembly of claim 1, further comprising a surface modification on the physical adhesion layer to enhance mechanical adhesion and intermolecular forces, wherein the surface modification includes texturing to increase surface area for adhesion.

5. The laminated film assembly of claim 1, wherein the physical adhesion layer is characterized by a thickness that optimizes the balance between flexibility for ease of application and rigidity for maintaining structural integrity when adhered to the glass surface.

6. The laminated film assembly of claim 1, wherein the CTA layer is treated to enhance its light-polarizing efficiency, thereby improving the obscuration of the contents of the display when viewed through the laminated film assembly.

7. The laminated film assembly of claim 1, wherein the physical adhesion layer is configured to be repositionable, allowing for detachment and reattachment to the glass surface without loss of adhesion quality or leaving residue on the glass surface.

8. The laminated film assembly of claim 1, wherein the physical adhesion layer includes a series of micro-suction structures to facilitate adhesion to the glass surface through the creation of a vacuum seal.

9. The laminated film assembly of claim 1, wherein the CTA layer and the physical adhesion layer are configured to allow for the transmission of touchscreen signals through the assembly, enabling interaction with a touchscreen display covered by the laminated film assembly.

10. The laminated film assembly of claim 1, further including an ultraviolet (UV) protection layer integrated into the CTA layer or disposed on a side of the CTA layer opposite the physical adhesion layer, to provide UV filtering properties when the laminated film assembly is applied to the glass surface.
